(19) United States
(12) Patent Application Publication
(10) Pub. No.: US 2019/0176424 A1
(43) Pub. Date: Jun. 13, 2019

(54) METHOD AND APPARATUS FOR FOOTWEAR MOULDING

(71) Applicant: Texon Management Limited, Saltburn-by-the-sea (GB)

(72) Inventors: Balasubramaniam VAIDHYANATHAN, Loughborough, Leicestershire (GB); George CHI-TANGYIE, Leicester, Leicestershire (GB); Aashu ANSHUMAN, Loughborough, Leicestershire (GB); Simon BRADSHAW, Coulby Newham, Middlesborough (GB)

(21) Appl. No.: 16/098,051

(22) PCT Filed: May 4, 2017
(86) PCT No.: PCT/GB2017/051244

§ 371 Date: Oct. 31, 2018

(30) Foreign Application Priority Data
May 4, 2016 (GB) 1607792.7

(51) Int. Cl. B29D 35/12; A43D 11/12; H05B 6/78

(52) U.S. Cl. CPC B29D 35/128; H05B 6/78; A43D 11/12

(57) ABSTRACT

The present invention provides a method of moulding a mouldable reinforcing element of an item of footwear. The method comprises the steps of: providing a microwave heatable mouldable reinforcing element and locating said element at an appropriate location as part of an item of footwear; positioning the item of footwear on a last to hold the item of footwear in an appropriate shape; locating the item of footwear in a microwave field within a microwave chamber that contains the microwave field and thereby heating the mouldable reinforcing element to a temperature at which it is mouldable; and moving the appropriate location of the item of footwear relative to the microwave field during said heating. The method is particularly advantageous over prior art microwave methods for moulding footwear in that it does not require specific control of the microwave field and it does not require the use of external moulds.

### FIELD OF INVENTION

The present invention relates to the manufacture of footwear. In particular, the present invention relates to the heating and moulding of mouldable reinforcing parts of footwear, such as heel counters and toe puffs, using microwave radiation. The invention is particularly suitable for the heating and moulding of heel counters. The invention is particularly advantageous over previously proposed microwave footwear heating and moulding apparatus and methods in that it does not require the use of a mould or precise control of a microwave field. Instead the footwear is positioned in a microwave field on a last and is moved relative to the field during heating. The relative motion may be achieved by moving the footwear and/or generating a moving microwave field.

### BACKGROUND

Many items of footwear contain heat mouldable reinforcing elements such as heel counters and toe puffs. These elements are generally formed of resilient polymers that are formed into a suitable shape and provide structure, strength and protection to the appropriate region of the footwear. For example, a major function of heel counters is to stiffen the back part of the footwear.

It is generally necessary to heat mouldable reinforcing elements during manufacture of footwear. In particular, this is done during, or immediately before, a moulding stage where the mouldable reinforcing element is moulded into the desired shape. This is because the materials used to form the mouldable reinforcing elements are necessarily rigid at room temperature and it is necessary to heat the materials to make them flexible enough to mould. After heating to a sufficient temperature they become plastic and can be formed into a new shape, which is maintained after cooling.

Mouldable reinforcing elements may be heated and moulded in-situ. For example, heel counters are heated when they form part of an at least partially formed piece of footwear. In particular, heel counters may be heated at the same time as other components of the footwear, such as leather or synthetic upper layers. A heel counter of a sports shoe may be heated whilst fixed to a polyurethane foam upper layer. This may be problematic as, while it is necessary to heat the heel counter to high temperature in order for it to be moulded, it may not beneficial to heat the other components of the footwear.

Further, after heating it is necessary to cool a mouldable reinforcing element in order to ensure shape retention. Heating other components of the footwear hinders the cooling process due to heat retained in those components. A related issue is that the presence of other components will slow conductive heating of a mouldable reinforcing element and it may be necessary to heat those other components to temperatures higher than the desired temperature of the counter in order to heat the counter sufficiently.

The above issues are particularly problematic with heel counters. Conventionally, heel counters are heated using a back part moulding machine. These machines utilise either heated air and/or heated moulds to heat the counter and a two part mould to mould the counter into a suitable shape. The heel counter is heated to between 70° C. and 90° C. depending upon the specific material from which they are formed. If the mould is heated the parts of mould are generally formed of metal and are heated to between 110° C. and 160° C. Heel counters are heated by inserting the appropriate component into the mould pressing the parts of the mould together and heating the components for between 30 and 40 seconds. After heating the components are removed from the moulding machine and are cooled at a cooling station. It is desirable to cool the components to the ambient temperature, which may be between about 20° C. and 40° C. depending upon the environment. However, as it is not only the heel counter that is heated, the cooling process is relatively slow. A typical cooling cycle only lasts 30 seconds and this is insufficient to reach the target temperature of between 20° C. and 40° C. Therefore, the components are generally not cooled to the optimum temperature but remain heated above the ambient temperature.

As will be readily appreciated, the current method of back part moulding has a number of issues. Components other than the heel counter are heated during the moulding, which is not desirable. Additionally and as a result, it is difficult to rapidly cool the counters after heating. Finally, the whole process is relatively slow, and can take over a minute to heat and cool an individual back part. In many shoe manufacturing processes the back part moulding is a bottleneck in the production line that substantially determines the rate at which shoes can be manufactured. In light of this it would be beneficial to have a back part moulding method and apparatus that is quicker and more efficient than current machines. Any such apparatus and method should allow more directed and quicker heating of a heel counter with less heating of the other components.

It has previously been proposed to use microwave heating in the place of conventional heating to speed up the moulding process when manufacturing footwear.

DE1963711A discloses a method of manufacturing footwear in which items of footwear are microwave heated before being positioned on a last.

FR2570580 purports to disclose a method of manufacturing footwear in which items of footwear, which may be positioned on a last, are passed on a moving conveyor through a microwave tunnel for heating. However, the disclosure of FR2570580 has numerous significant technical inaccuracies and so the disclosure of this document would be dismissed by the skilled person as technologically incorrect and therefore irrelevant. For example, FR25705780 states that the microwave tunnel disclosed therein is made of “low-loss dielectrics such as polyethylene, polypropylene, Teflon, silicone etc. which block microwaves . . . ” None of these materials block microwaves.

WO2015075435 in the name of Texon Management Ltd discloses a microwave toe puff or heel counter heater comprising an inner mould and an outer mould and a microwave generator that is formed to direct microwave radiation to a space formed between the inner mould and the outer mould. In this heater the inner mould and/or the outer mould comprises cooling means for cooling the mould. Although this document discloses microwave heating it still utilises a substantially conventional moulding process in conjunction with the microwave heating.

WO2014150849, WO2014150839 WO2014150852, WO2014150861 all in the name of Nike Innovate C.V. disclose the microwave heating of shoe components in a chamber. These applications generally relate to the microwave heating of a shoe sole in a chamber in order to join together an EVA foam midsole and a rubber outsole. The chamber may have components such as waveguides, ports, a cage, a distribution plate and dielectric materials, in order to precisely control the energy distribution of microwave energy within the chamber to properly heat a shoe sole placed within the chamber. For example, the chamber may be formed to produce a standing wave within the chamber. The disclosure of each of these documents is that it is desirable, if not essential, to precisely control microwave energy distribution within a heating chamber when that chamber is used to heat shoe components.

In light of the above, there remains a need for a simple and quick method and apparatus for moulding mouldable reinforcing elements, such as heel counters, during a footwear manufacturing process. Preferably any such method and apparatus should not require complex control of microwave energy distributions and should be capable of replacing current back part moulding processes.

### SUMMARY OF INVENTION

The present invention provides a method of moulding a mouldable reinforcing element of an item of footwear comprising the steps of:
providing a microwave mouldable reinforcing element and locating said element at an appropriate location as part of an item of footwear;
positioning the item of footwear on a last to hold the item of footwear in an appropriate shape;
locating the item of footwear in a microwave field within a microwave chamber that contains the microwave field and thereby heating the mouldable reinforcing element to a temperature at which it is mouldable; and
moving the appropriate part of the item of footwear relative to the microwave field during said heating.

The method of the present invention can be used to mould any suitable mouldable reinforcing element including, but not limited to, heel counters, toe puffs, and side reinforcing elements. These elements can be heated separately or at the same time. Generally, if an item of footwear contains more than one mouldable reinforcing element it may be preferable that all such elements are heated and moulded at the same time. The mouldable reinforcing element may be formed within the item of footwear, for example inserted within a pocket between an upper and a lining. It may also be possible that the mouldable reinforcing element is an external element, such as a toe cap. An external mouldable reinforcing element may be formed by spraying a liquid dispersion onto an upper of an item of footwear or may be provided as a pre-formed element in the same manner as a heel counter.

The method of the present invention is advantageous in that it can significantly speed up a moulding process when manufacturing an item of footwear. The method is particularly suitable for a back part moulding process. The method utilises microwave heating and removes the need to position the relevant part of the footwear in a mould and apply direct heat to that part. The need to position the item of footwear in separate hot and cold moulds can be entirely removed from the process for manufacturing footwear. The method of the present invention can reduce the time taken for back part moulding from its current time of 30 to 60 seconds (including cooling) to 15 seconds or less. This removes a significant bottleneck in the production of footwear and has the potential to greatly increase the efficiency of footwear production.

After carrying out the method of the present invention the last may either be retained within the item of footwear whilst the item of footwear undergoes subsequent manufacturing processes or it may be removed before subsequent manufacturing processes. For example, the last may be retained in place after heating for external pressure to be applied using a heel seat lasting process or airbag press to provide shape and bonding before a sole is fixed in place. It may be preferable that the item of footwear goes through a chilling tunnel or other cooling means before the last is removed but this may not always be necessary.

In order for the method of the present invention to function it is necessary that the mouldable reinforcing element of the item of footwear is formed of a suitable material, A suitable material is one that has a high susceptibility to microwave heating and that is mouldable when heated. Microwave absorption within a material is primarily determined by the dielectric loss tangent of the material. A material may be considered to have a suitably high dielectric loss tangent for microwave heating if it has a dielectric loss tangent of 0.05 or higher.

Some materials that are currently used for mouldable reinforcing elements, such as heel counters, have a suitably high dielectric loss tangent. For example, a polymer blend of TPU (65%) and PMMA (35%) has a dielectric loss tangent of 0.1 and is suitable for microwave heating. In this material it is the TPU that contributes to microwave heating.

Mouldable reinforcing elements formed of this material are suitable for use with the present invention. However, many current materials do not have a suitably high dielectric loss tangent. In fact, most low cost composites currently used for heel counters do not contain TPU and are not microwave receptive i.e. they have a dielectric loss tangent less than 0.05. These blends include but are not limited to composites of PET, PP and EVA.

In light of the above it may be preferable that mouldable reinforcing elements, such as heel counters, used with the present invention are formed of materials that are modified from existing materials to make them optimal for microwave heating. For example, GB1442637 and U.S. Pat. No. 4,069,602 disclose heel counters and toe puffs that are formed of polymers that have had carbon black, carbon black preparations, carbon black compounds, or graphite added in order to make them suitable for microwave heating. Further examples of suitably modified materials are disclosed in GB1320430.0.

For any specific mouldable reinforcing element the temperature to which that element is required to be heated in order to allow it to be moulded will be apparent to the skilled person. The skilled person would then be able to control the method of the present invention appropriately to ensure that the mouldable reinforcing element is heated to an appropriate temperature and not so far beyond that temperature to damage either the mouldable reinforcing element or the item of footwear.

The method of the present invention is carried out as follows. The method is described for back part moulding but it will be understood that the method can be suitably modified to mould any other part of an item of footwear comprising a mouldable reinforcing element. The method of the present invention may be used to mould several mouldable reinforcing elements within an item of footwear.

First, a suitable heel counter is provided in an appropriate position in a back part of an item of footwear. The heel counter may be completely enclosed in the back part, for example by stitching in place. The heel counter will generally be unmoulded at this point and may be a flexible but flat counter before positioning within the item of footwear. Next the item of footwear may be either cemented or stitched to an insole (i.e. Strobel construction) before inserting a shaped last inside the shoe to form the back part of the footwear. External pressure is then applied after heating the heel counter in the microwave field to form the item of footwear an appropriate shape. For example using a heel seat lasting machine or airbag press.

The last is preferably formed of a material that is not susceptible to microwave heating such that it does not heat significantly during the method of the present invention. It is also preferable that, other than the heel counter, the back part of the item of footwear is not formed of materials that are susceptible to microwave heating such that the back part does not heat significantly during the method of the invention. In most items of footwear this will not be a concern as typically the back parts of items of footwear are not formed of materials susceptible to microwave heating. Although it is generally preferable that the last is formed of materials that are transparent to microwave heating it is possible for the last to comprise components that are not transparent to microwave heating. For example, the last may be a metal hinged last.

After positioning on the last the back part of the item of footwear is located in a microwave field that will act to heat the heel counter within the back part and thereby mould the heel counter into the position in which it is held by its positioning on the last. The heel counter will be heated to an appropriate temperature to achieve this result. The time taken to achieve this heating will depend on a number of factors including, hut not limited to, the material of the heel counter and the strength of the microwave field.

During heating the back part of the item of footwear will be moved relative to the microwave field. As discussed below, this can be achieved by moving the back part and/or moving the microwave field. The method of the present invention does not hold the back part static in a static microwave field during heating. The motion of the back part relative to the microwave field ensures more uniform heating of the heel counter. This greatly simplifies the requirements of a microwave heating apparatus that can be used with the method of the present invention as compared to the prior art methods that generally required precise control of both the microwave field and the location of the item of footwear within the microwave field in order to achieve the desired heating of the item of footwear.

In embodiments of the method of the present invention the microwave field will be located within a suitable microwave chamber. That is, during the step of locating the item of footwear within a microwave field the item of footwear is positioned within a microwave chamber that is used to isolate the microwave field from the surrounding environment, that is the microwave chamber contains the microwave field. For example, the microwave chamber may comprise an outer faraday cage to contain microwave radiation or the microwave chamber may be formed of a material that blocks microwaves.

In order to move the appropriate part or parts of the item of footwear relative to a microwave field within a microwave chamber the item may be located on a movable mount or support such that during heating the mount is moved within the chamber to move the item of footwear relative to the microwave chamber. In such embodiments of the invention the microwave field may be substantially stationary within the chamber, that is the field pattern of the microwave field may be substantially stationary during heating of the heel counter. Alternatively, the microwave field may also be moving relative to the microwave chamber.

As discussed below in relation to the apparatus of the present invention a mount may be formed in any appropriate manner and may be moved in one or more of a variety of motions. For example, the mount may be oscillated and/or rotated during heating. The mount may be oscillated or rotated in any direction or directions that allow the back part to remain mounted on the mount.

As a microwave field may be expected to be substantially symmetrical within a microwave chamber it may be preferable that a mount is moved asymmetrically within the chamber to ensure more uniform heating of the appropriate part or parts of the item of footwear. A mount is moved asymmetrically within a microwave chamber if it is not rotated or oscillated about a line of symmetry of the microwave chamber or a line of symmetry of a stationary microwave field within the microwave chamber, Moving the mount asymmetrically within a microwave chamber can achieve more uniform heating of an item of footwear located on the mount, This can further reduce or remove the need for precise design and control of the microwave field within the microwave chamber.

In addition, or as an alternative, to moving the appropriate part during microwave heating the microwave field within which the item of footwear is located may not be stationary. That is, the field pattern of the microwave field may not be stationary but may be moving and variable during the heating of the mouldable reinforcing element. This can be achieved in any manner apparent to the person skilled in the art. One method of achieving a moving microwave field is to utilise one or more mode stirrers. Mode stirrers are well known within the field of microwave heating.

During the heating step of the present invention the item of footwear may be held in position within the microwave field and potentially moved within that field on a mount, see above. Alternatively, during heating the item of footwear may be moved through the microwave field on a conveyor such that the heating of the heel counter is achieved as part of a continuous production line. Further the relative motion of the appropriate part of the item of footwear relative to the microwave field may be, at least partially, achieved by moving the item of footwear through the microwave field on the conveyor.

The present invention also provides a footwear moulding heater comprising:
a microwave chamber;
a microwave generator that, when in use, generates a microwave field within the microwave chamber, wherein the microwave field is contained within the chamber;
apparatus for moving an item of footwear located in the chamber relative the microwave field;
a support plate for locating the item of footwear formed of microwave transparent material; and
an actuator for moving the support plate relative to the chamber, wherein the actuator oscillates and/or reciprocates the support plate in the chamber.

The heater of the present invention is intended to be used with the method of the present invention and may comprise further components that make it particularly suitable for embodiments of the present invention that are discussed above.

The heater of the present invention is particularly advantageous over previous microwave heaters intended for use with items of footwear in that no precise control of the microwave field is required. Instead uniform heating of a mouldable reinforcing element of an item of footwear is achieved by having apparatus that moves the item of footwear relative to a microwave field within the chamber. This relative motion of the item of footwear and the microwave field allows substantially uniform heating of the appropriate part of an item of footwear without requiring precise control of the microwave field. Further, due to the use of the method of the present invention with the heater of the present invention it is not necessary for the heater to comprise a mould, instead moulding is achieved by microwave heating the mouldable reinforcing element whilst it is in position and the item of footwear is positioned on a suitable last.

In order to allow suitable positioning of an item of footwear within the heater the heater comprises a support plate for locating the item of footwear. Preferably the support plate will be formed of a material that is not susceptible to microwave heating such that it does not heat appreciably during repeated use of the heater. A support plate may be formed of a suitable polymer that is substantially transparent to microwaves, such as HDPE or PTFE or polypropylene.

The support is formed such that an item of footwear can be located on an upper surface of the support. In order to help hold an item of footwear in place on the upper surface the upper surface may have one or more indented portions. The indented portions may comprise one or more grooves or may be formed substantially in the shape of the sole of the item of footwear or may be formed in any other manner that will assist in holding an item of footwear in position.

A support is formed such that, when an item of footwear is supported thereon, it can be moved relative to the chamber of the heater. This is achieved by the actuator for moving the support plate relative to the chamber. For example, the support plate may be mounted in the chamber on a shaft that extends out of the chamber to an actuator that thereby moves the support plate within and relative to the chamber.

The actuator acts to oscillate and/or reciprocate the support plate in the chamber. This may be done in a horizontal plane, a vertical plane, or in any other direction or combination of directions. In an embodiment of the invention the support plate may be moved by an actuator in a reciprocal motion through an angular arc in a horizontal plane.

In order to ensure uniform heating of a mouldable retaining element in an item of footwear it may be preferable that any movement of a support plate is asymmetrical with respect to the chamber. That is, that the support plate is not precisely located such that an item of footwear is precisely central within the chamber and that the movement of the support plate does not result in an average position of the item of footwear being precisely central within the chamber.

In addition, or as an alternative to, the apparatus for moving an item of footwear relative to the microwave field comprising means for moving the item of footwear relative to the chamber the apparatus may comprise means for moving the microwave field relative to an item of footwear located in the chamber. An example of a suitable means for moving the microwave field is a mode stirrer. Other similar means will be apparent to the person skilled in the art.

A heater according to the present invention may be formed such that the chamber is open at a first end and a second end and the apparatus comprises a conveyor belt for moving an item of footwear through the chamber from a first end to a second end. In this manner a heater according to the present invention can form part of a footwear production line. Such a heater may have openable doors at opposing ends that are closed when necessary in order to contain a microwave field within the chamber.

Alternatively, a heater according to the present invention may form part of a system that additionally comprises a conveyor for moving the items of footwear and an actuator for moving the items of footwear from the conveyor into the heater and for removing the items of footwear after they have been heated. Such a system may operate as part of a footwear production line to manufacture many items of footwear. The conveyor and actuator may be formed in any manner apparent to the person skilled in the art. The items of footwear may be moved along the conveyor in position on a support plate that is then positioned appropriately in the heater by the actuator. That is, each item of footwear or pairs of items of footwear may be moved along at least part of the production line in position on a support plate and may be positioned within and removed from the heater whilst remaining in position on the support plate. As an alternative, the items of footwear may be moved from the conveyor by the actuator into position on a support plate that is permanently located within the chamber of the heater.

Further features and advantages of the present invention will be apparent from the embodiments that are shown in the Figures and are described below.

Drawings

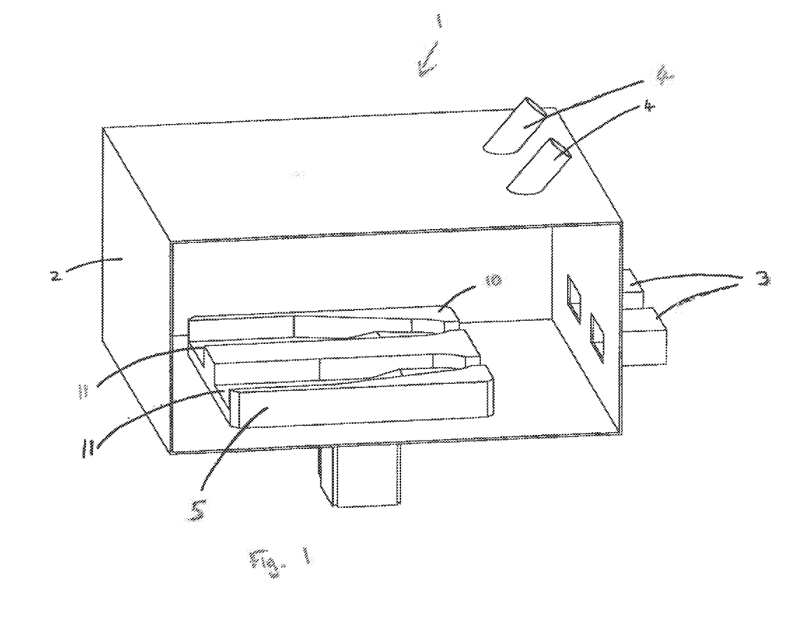

FIG. 1 is a diagram of a back part heater according to a first embodiment of the invention;

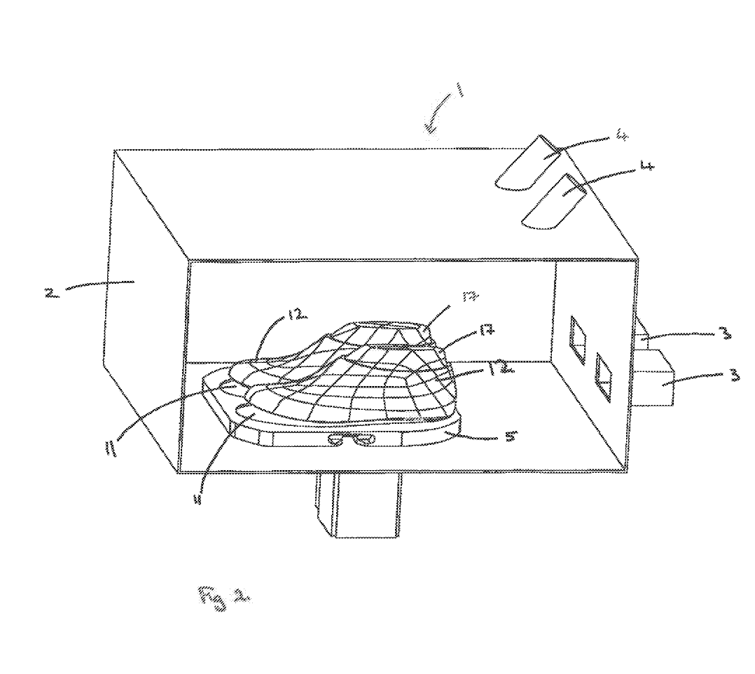

FIG. 2 shows the back part heater of FIG. 1 with an item of footwear positioned inside;

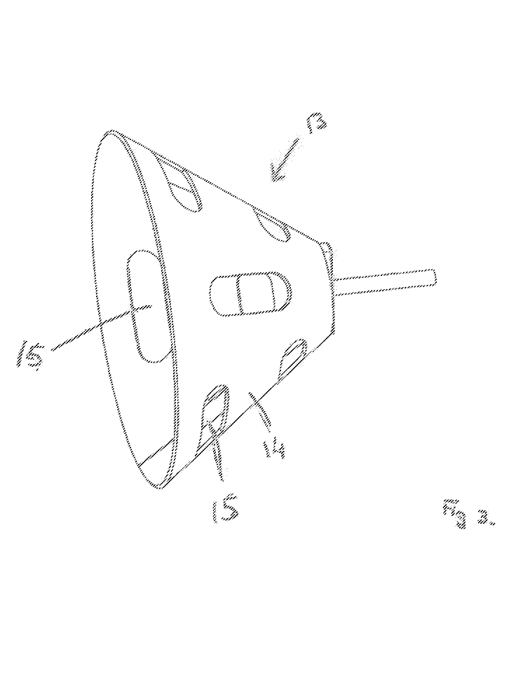

FIG. 3 shows a mode stirrer that may be used with a back part heater according to the present invention;

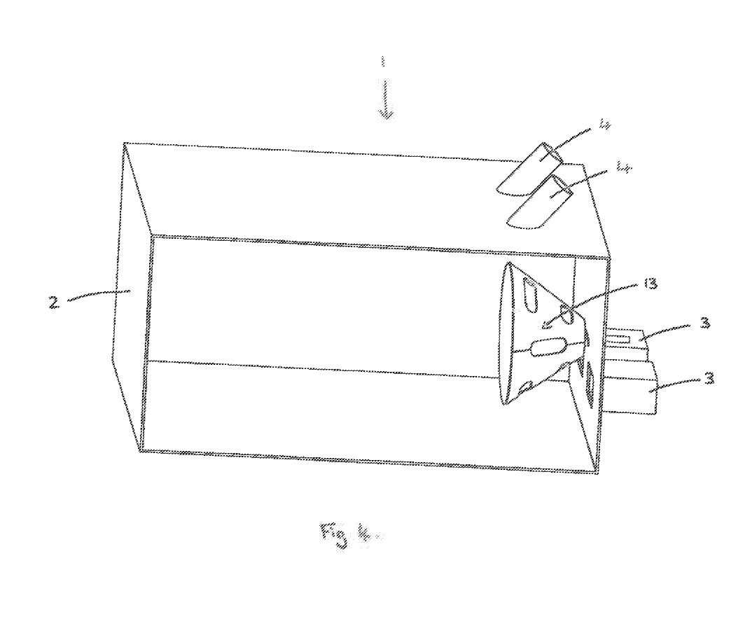

FIG. 4 shows the mode stirrer of FIG. 3 in position in the back part heater of FIG. 1;

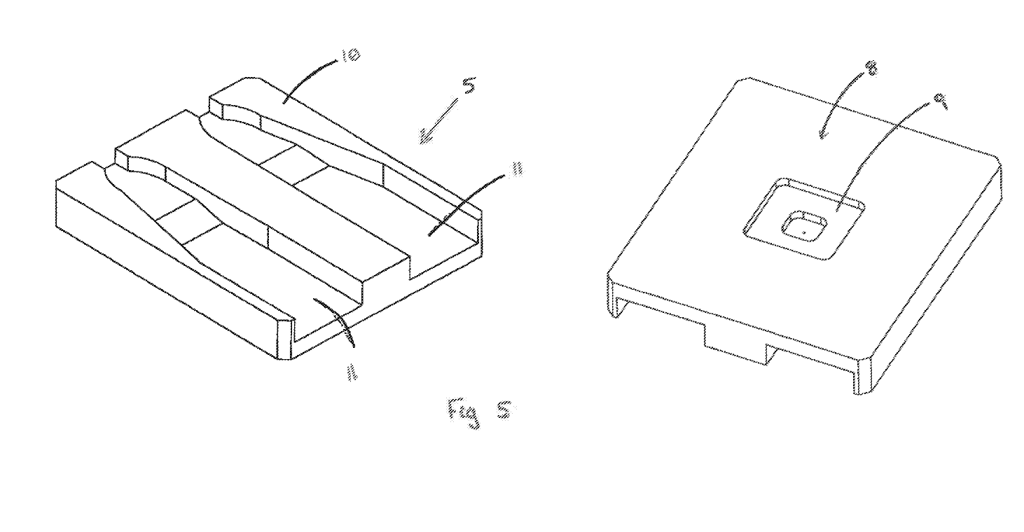

FIG. 5 shows detail of a support plate of the back part heater of FIG. 1;

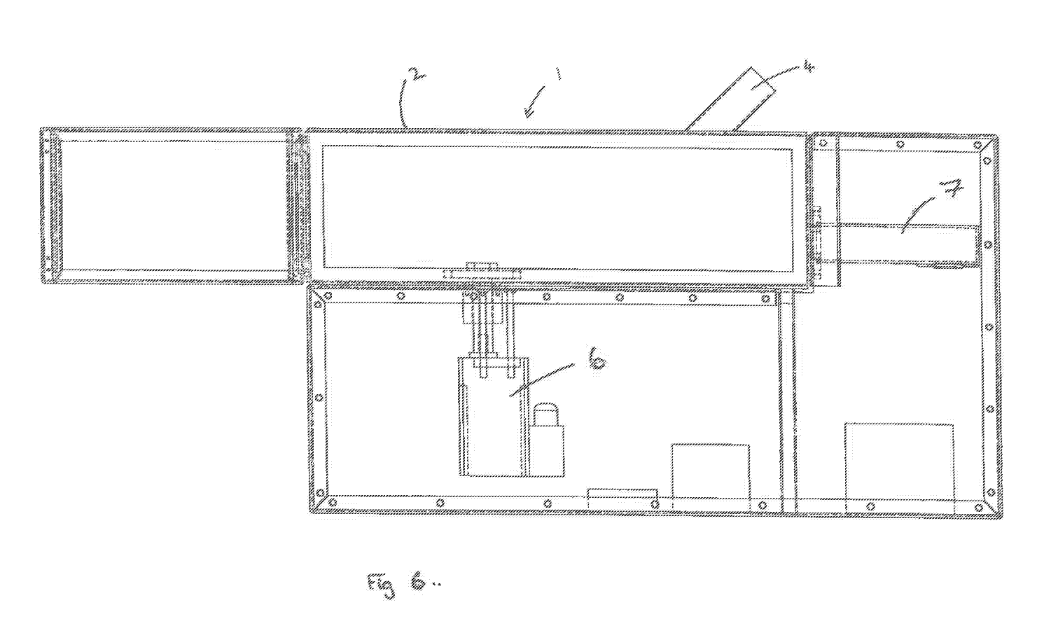

FIG. 6 is a cross-section of the back part heater of FIG. 1 showing detail of the actuator;

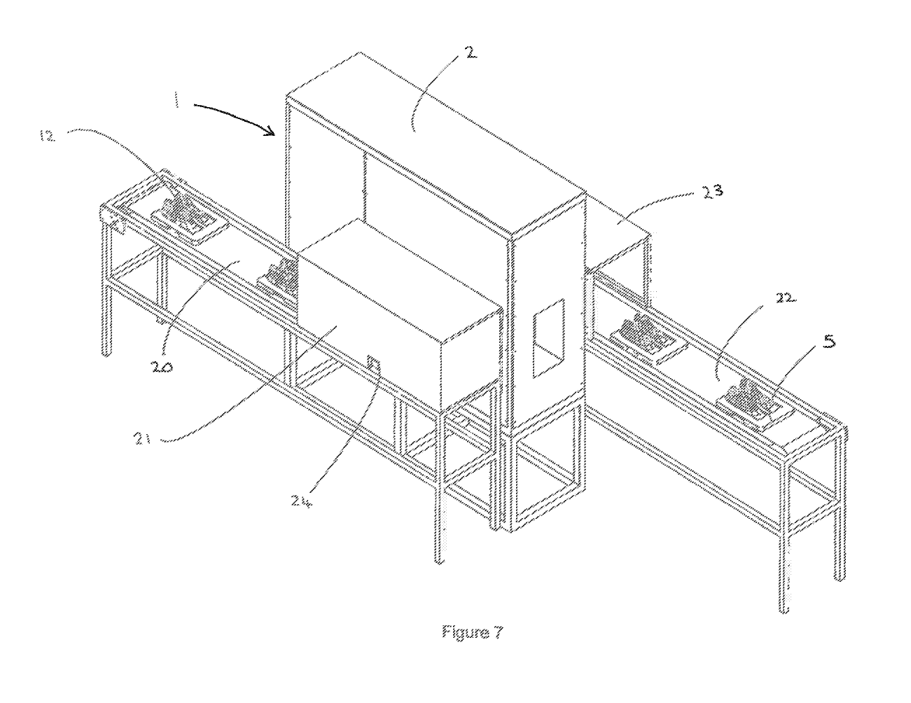

FIG. 7 is a schematic diagram of a first system for moulding footwear components comprising a back part heater according to the present invention; and

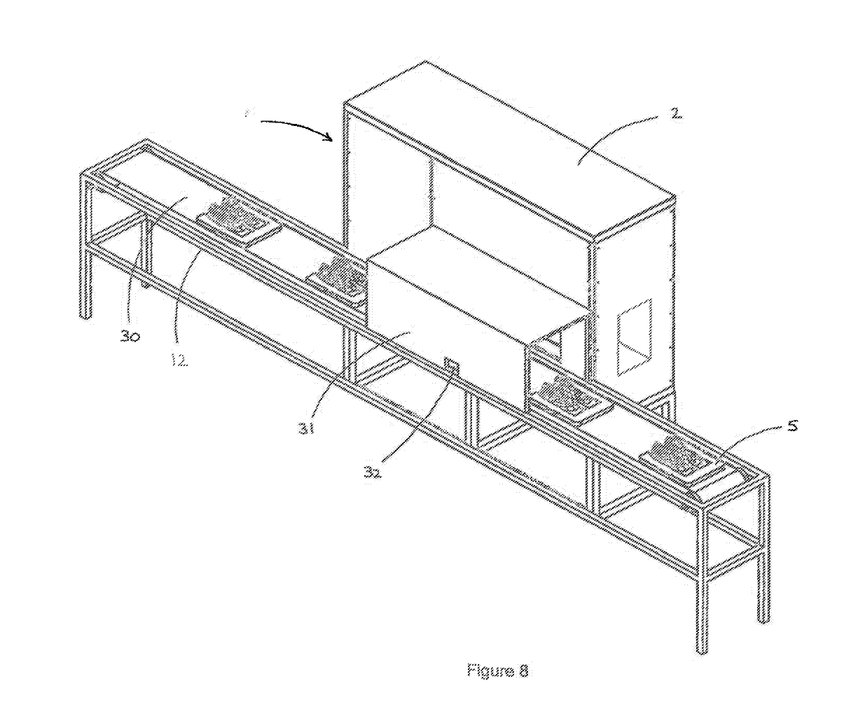

FIG. 8 is a schematic diagram of a second system for moulding footwear components comprising a back part heater according to the present invention

A back part heater 1 according to an embodiment of the present invention is shown in the Figures. The heater 1 comprises a chamber 2, two ports 3 for introducing microwave radiation, inspection apertures 4, a support plate 5, an actuator 6, and two magnetrons 7, each aligned with one of the ports 3.

Details of the support plate 5 can be seen in FIG. 5. The support plate 5 is mounted in the chamber at an upper end of the actuator 6. A lower surface 8 of the support plate 5 has a central mounting 9 formed therein by which the support plate can be fixed to the upper end of a shaft of the actuator 6. An upper surface 10 of the support plate 5 has two mounting indentations 11 formed therein. The indentations 11 are shaped to accept an item of footwear 12 and to hold the item of footwear 12 in position on the upper surface. The support plate 5 is formed from a microwave transparent material such as HDPE, polypropylene, or PTFE.

During use of the heater 1 an item of footwear 12 is positioned in each of the indentations 11 of the support plate 5. The items of footwear 12 may be a pair of shoes. Each of the items of footwear 12 is mounted on a last 17 to hold it in the appropriate position for moulding a back part of a shoe. In particular, the last 17 will be shaped to form a heel counter (not shown) positioned in the back part of the shoe 12 to an appropriate shape.

During operation of the heater 1 the actuator 6 operates to rotate the support plate 5 in an oscillating motion at variable angles. The actuator 6 is capable at rotating the support plate 5 at speeds from 0.5 rpm to 30 rpm. The angle of oscillation may be anywhere from 0° to 360° in a clockwise or counter clockwise direction. A shaft of the actuator 6 is capable of variations of height enabling a variation of height of the support plate 5 in the chamber 2. The shaft of the actuator 6 can be formed of either microwave transparent or microwave conducting material, The height of the support plate 5 may be varied during operation of the heater 1 in combination with the oscillating rotation of the support plate 5. Moving the support plate within the chamber 2 ensures uniform exposure of a back part of a shoe to a microwave field within the chamber 2 even if the microwave field within the chamber 2 is not uniform.

A mode stirrer 13 of a heater 1 according to the present invention is shown in FIG. 3. The mode stirrer 13 is used to disperse the microwave energy in the chamber 2 by continuously varying the resulting microwave field. The mode stirrer 13 is a rotating mechanical device comprising a conical swatch plate 14 having apertures 15 formed therein. In use the mode stirrer 13 is mounted immediately above a port 3 and is rotated to disperse the microwave energy as it introduced into the chamber 2 via the port 3 and provide a varying microwave field, which on average is more uniform. The mode stirrer 13 is an optional feature and may not be present in embodiments of the invention.

In use, microwave energy is introduced into the chamber by the magnetrons 7 via the ports 3. The entry ports 3 are covered by microwave transparent windows made of material such as PTFE or HDPE, although in alternative embodiments of the invention the entry ports 3 or uncovered. The ports 3 form waveguides to help guide the microwave energy from the magnetrons 7 into the chamber 2. In the embodiment shown in the Figures the magnetrons 7 generate microwaves at either 2450 MHz or 915 MHz although it is possible to use alternative microwave frequencies.

The heater 1 can be used to implement the method of the present invention in the following manner. An unmoulded heel counter (not shown) is positioned appropriately in the back part of each of the items of footwear 12. The items of footwear 12 are then. positioned on a last 17 to form the heel counter into an appropriate shape. The heel counter is formed of a material that is mouldable when heated and that is susceptible to microwave heating. The items of footwear 12 are then positioned in the chamber 2 in the indentations 11 in the upper surface of the support plate 5. The items of footwear 12 may be positioned in the chamber 2 through a door (not shown) in the side of the chamber 2.

When the items of footwear 12 are in position within the chamber 2 and the door is closed to seal the chamber, the actuator 6 is operated to oscillate the support plate 5 within the chamber 2 and the magnetrons 7 are operated to direct microwave energy into the chamber 2. If the heater 1 comprises one or more mode stirrers 13 these will be rotated to disperse the microwave energy in the chamber 2. As a result, the items of footwear 12 will be exposed to a microwave field and will be constantly moved relative to that field. This allows for uniform microwave heating of the heel counters.

After an appropriate amount of heating the magnetrons 7 will be turned off, the oscillation of the support plate 5 will be halted, and the items of footwear 12 will be removed from the chamber. The items of footwear 12 may then be moved on to further processing. An appropriate amount of heating is an amount that results in the heel counters being heated to a temperature at which they become mouldable. It is anticipated that the skilled person would be able to optimise any particular embodiment of the present invention to allow this to happen based on the power of the magnetrons 7, the specific items of footwear 12, the material of the heel counters, and other relevant engineering considerations. Whilst it is necessary that the heel counters are heated to a sufficient temperature it is undesirable to overheat the heel counters as this can damage them or the items of footwear 12 in which they are contained.

It is anticipated that only components of items of footwear 12 that are susceptible to microwave heating will be significantly heated during use of the heater 1 according to the method of the present invention. Other components that are not susceptible to microwave heating will remain cool and will only be heated to the extent that they absorb heat from the microwave heated components.

From trials conducted using the embodiment of the invention of FIGS. 1 to 6, a pair of lasted uppers comprising microwavable counters were successfully uniformly activated in under 15 seconds using a 2 kW, 2.45 GHz microwave field. The support plate was oscillated through an angle of rotation of 20° at a frequency of 3.5 rpm. The counters achieve a temperature of 95° C. whilst the adjoining uppers were heated to only 45° C. No detrimental effects of this process on either the uppers or the counters were discovered. This result has been achieved for a variety of footwear sizes and types. The trials were equally successful for synthetic easily wrinkled, stretchy, non-stretchy materials,—and leather. For leather footwear the upper temperature may be raised above 45° C. due to microwave heating resulting from oil, moisture and pigment content in the material. Leather uppers that have been successfully processed using the apparatus of

FIGS. 1 to 6 were heated to substantially lower temperatures than would be obtained if they had been processed traditional backpart moulding, in particular none of the leather uppers were heated above 90° C.

As the microwavable counters were selectively microwave heated the adjoining uppers were heated to a significantly lower temperature than in conventional moulding techniques, where the upper temperature would be at least as high as the temperature of the counter. This provides significant benefits. For example, the heated product is easier to handle, there is less risk of damage to the uppers, and the cooling time can be significantly shorter, potentially eliminating the need for a cooling stage in the manufacturing process. In addition minimising the heating of the uppers introduces the possibility of using materials that would not previously have been considered due to their intolerance of high temperatures.

A first system for moulding footwear components comprising a back part heater 1 according to the present invention is shown in FIG. 7. The system comprises a back part heater 1 according to the present invention, a first conveyor 20, a first shield screen 21, a second conveyor 22, a second shield screen 23, and an actuator 24.

A second system for moulding footwear components comprising a back part heater 1 according to the present invention is shown in FIG. 8. The system comprises a back part heater 1 according to the present invention, a conveyor 30, a shield screen 31, and an actuator 32.

The back part heaters 1 of the systems of FIGS. 7 and 8 is substantially as shown in FIGS. 1 to 6 and as described above with the exceptions that the support plate 5 is removable and that the back part heater 1 of the system of FIG. 7 is openable on a first side and an opposing second side. The back part heater 1 of the system of FIG. 8 is openable only on a first side.

The system of FIG. 7 operates in the following manner.

An unmoulded heel counter (not shown) is positioned appropriately in the back part of items of footwear 12. The items of footwear 12 are then positioned on a last to form the heel counter into an appropriate shape. The heel counter is formed of a material that is mouldable when heated and that is susceptible to microwave heating. The items of footwear are then position in the indentations in the upper surface of a support plate 5. The support plate 5 is then placed on the upper surface of an outer end of the first conveyor 21. The first conveyor 21 then moves the support plate from its first end to a second end that is adjacent the back part heater 1 and within the first shield screen 21. At this point the back part heater 1 is opened at both a first side adjacent the first shield screen 21 and a second side adjacent the second shield screen 23. The actuator 24 then acts to move the support plate 5 from the first conveyor 20 into the chamber 2 of the back part heater 1 such that the support plate 5 is appropriately located on the actuator 5 of the chamber 2. The back part heater 1 is then closed and the items of footwear 12 are microwave heated whilst being oscillated in the manner described above.

When the heating of the items of footwear 12 is completed the back part heater 1 is opened. The actuator 24 then acts to move the support plate 5 and the items of footwear 12 from the chamber 2 to a first end of the second conveyor 22 that is positioned within the second shield screen 23. The second conveyor 22 then moves the items of footwear 12 from the first end to a second end. The items of footwear 12 are then removed from the system.

The first screen shield 21 and the second screen shield 22 act to protect users from mechanical entrapment by the actuator 24 and any other moving parts of the system.

If the back part heater 1, and in particular any microwave field generated therein, is suitably formed it may be possible for the chamber 2 of the back part heater 1 to be permanently open at its first side and its second side.

As will be readily understood and as shown in the Figure, multiple items of footwear can be processed by the system of FIG. 7 consecutively. The system of FIG. 7 is intended to be an automated part of a footwear production line.

The system of FIG. 8 operates in a similar manner to the system of FIG. 7 with the exception that items of footwear are moved by the actuator 32 from the conveyor 30 into the chamber 24 and, after microwave heating, are then moved back onto the same conveyor from the same side of the chamber 2.

1.-17. (canceled)

18. A method of moulding a mouldable reinforcing element of an item of footwear comprising the steps of:
providing a microwave heatable mouldable reinforcing element and locating said element at an appropriate location as part of an item of footwear;
positioning the item of footwear on a last to hold the item of footwear in an appropriate shape; and then
locating the item of footwear in a microwave field within a microwave chamber that contains the microwave field and thereby heating the mouldable reinforcing element to a temperature at which it is mouldable; and
moving the appropriate location of the item of footwear relative to the microwave field during said heating.

19. A method according to claim 18, wherein the mouldable reinforcing element is a heel counter and the appropriate location is a back part of the item of footwear.

20. A method according to claim 18, wherein the mouldable reinforcing element is a toe puff and the appropriate location is a front part of the item of footwear.

21. A method according to claim 18, wherein the item of footwear is located on a movable mount within the microwave chamber and during heating the mount is moved within the chamber to move the item of footwear relative to the microwave chamber.

22. A method according to claim 21, wherein the mount is rotated during heating.

23. A method according to claim 22, wherein the mount is oscillated during heating.

24. A method according to claim 22, wherein the mount is oscillated or rotated asymmetrically within the chamber.

25. A method according to claim 18, where the microwave field within which the item of footwear is located is not stationary.

26. A method according to claim 25, wherein the microwave field is moved relative to the item of footwear using at least one mode stirrer.

27. A method according to claim 18, wherein the item of footwear is moved through the microwave field on a conveyor.

28. A method according to claim 18, wherein the last is formed of a microwave transparent material.

29. A footwear moulding heater comprising:
a chamber;
a microwave generator that, when in use, generates a microwave field within the chamber, wherein the microwave field is contained within the chamber;
an apparatus for moving an item of footwear located in the chamber relative the microwave field;
a support plate for locating the item of footwear, wherein the item of footwear is formed of microwave transparent material; and
an actuator for moving the support plate relative to the chamber, wherein the actuator oscillates the support plate in the chamber.

30. The footwear heater of claim 29, further comprising a back part moulding heater according to claim 29.

31. The footwear heater according to claim 29, wherein the support plate is formed of HDPE or PTFE or polypropylene.

32. The footwear heater according to claim 29, wherein the support comprises one or more indented portions on an upper surface in which a shoe can be located.

33. The footwear heater according to claim 29, wherein the apparatus comprises at least one mode stirrer for moving the microwave field within the chamber and relative to a shoe located in the chamber.

34. The heater according to claim 29, wherein the heater is part of a system for moulding footwear components, the system comprising the heater and a conveyor for bringing an item of footwear to the heater; and an actuator for moving the item of footwear from the conveyor into the chamber of the heater and removing it after heating.
